(19) United States
(12) Patent Application Publication
(10) Pub. No.: US 2023/0128262 A1
(43) Pub. Date: Apr. 27, 2023

(54) Modular Robotic Inspection System

(71) Applicants: Lockheed Martin Corporation, Bethesda, MD (US); Southem Methodist University, Dallas, TX (US)

(72) Inventors: Christopher Lee Colaw, Fort Worth, TX (US); Adam Britton Cox, Dallas, TX (US); Matthew E. Galla, Fort Worth, TX (US); Yildirim Hurmuzlu, McKinney, TX (US); Jose Jaime Lafon, Fort Worth, TX (US); Francisco Joaquin Martinez, Fort Worth, TX (US); Edmond Richer, Richardson, TX (US)

(21) Appl. No.: 17/511,237

(22) Filed: Oct. 26, 2021

(51) Int. Cl. F16L 55/32; F16L 55/44

(52) U.S. Cl. CPC F16L 55/32; F16L 55/44; F16L 2101/30

(57) ABSTRACT

In embodiments, systems and methods include using a modular robotic inspection system to inspect a tubular of a vehicle or building. The modular robotic inspection system comprises a first modular robot and a second modular robot. Both the first modular robot and the second modular robot comprise a base, a plurality of wheels disposed around the base, wherein each of the plurality of wheels is coupled to the base through a set of extendable arms, wherein each one of the plurality of wheels is disposed at a distal end of one of the set of extendable arms, and a plurality of centralizing rollers disposed around the base, wherein each one of the plurality of centralizing rollers is disposed at a proximal end of one of the set of extendable arms. The first modular robot further comprises a motor operable to actuate the plurality of wheels of the first modular robot.

### TECHNICAL FIELD

This disclosure generally relates to inspecting tubulars, and more specifically to a modular robotic inspection system utilized for inspecting tubulars of an aircraft.

### BACKGROUND

Inspection within tubulars of vehicles is essential to maintenance and serviceability. There exists a problem in inspecting inside these tubulars as existing systems and methods use a borescope unable to effectively pass through bends in the tubular and to travel in all orientations.

### BRIEF DESCRIPTION OF THE DRAWINGS

To assist in understanding the present disclosure, reference is now made to the following description taken in conjunction with the accompanying drawings, in which:

FIG. 1 illustrates an example modular robotic inspection system, according to certain embodiments;

FIG. 2 illustrates an example first modular robot of the modular robotic inspection system in FIG. 1, according to certain embodiments;

FIG. 3 illustrates an example second modular robot of the modular robotic inspection system in FIG. 1, according to certain embodiments; and

FIG. 4 illustrates an example base unit of the modular robotic inspection system in FIG. 1, according to certain embodiments.

### DETAILED DESCRIPTION

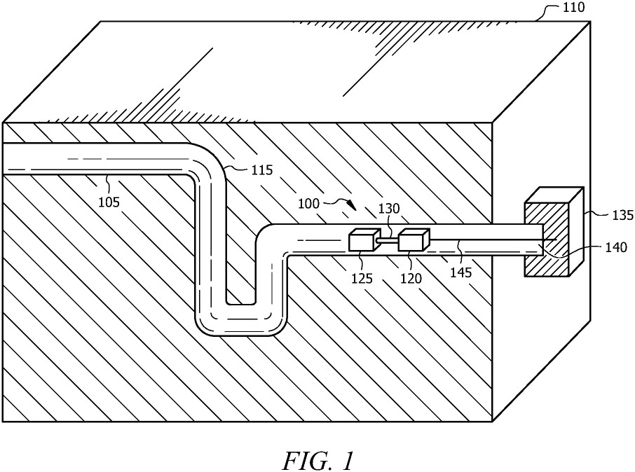

To facilitate a better understanding of the present disclosure, the following examples of certain embodiments are given. The following examples are not to be read to limit or define the scope of the disclosure. Embodiments of the present disclosure and its advantages are best understood by referring to FIGS. 1 through 4, where like numbers are used to indicate like and corresponding parts.

As described, the tubulars within vehicles may require inspection for periodic or routine maintenance. It may be difficult to accurately inspect within the tubular or measure a parameter within the tubular with existing systems. Described herein are various systems and methods that provide for autonomous inspection and maintenance procedures within a tubular by using a modular robotic inspection system.

FIG. 1 illustrates an example modular robotic inspection system 100 at least partially disposed within a tubular 105. The tubular 105 may be any suitable tubular, conduit, piping, and the like. In one or more embodiments, the tubular 105 may be disposed through a vehicle 110. Any suitable type of vehicle may be used as the vehicle 110. Without limitations, vehicle 110 may be any type of vehicle, including an aircraft, a spacecraft (i.e., a satellite), a landcraft, a watercraft, a train, a hovercraft, and a helicopter. In one or more embodiments, the tubular 105 may be disposed within a building (not shown) or other suitable structure in accordance with the present disclosure. In embodiments, the modular robotic inspection system 100 may be operable to be at least partially introduced into the tubular 105 and to perform operations while travelling through the tubular 105. For example, the modular robotic inspection system 100 may be operable to autonomously travel through the tubular 105, inspect the interior of the tubular 105, measure a parameter of the tubular 105, and combinations thereof. In one or more embodiments, the length of the tubular 105 may generally be in a straight line. As illustrated, the tubular 105 may further comprise a bend 115 along the length of the tubular 105, wherein the bend 115 may comprise any suitable angle in relation to a central axis of the tubular 105 at any suitable radial direction from the central axis. Without limitations, the bend 115 may comprise an angle within a range of about 0° to about 30°, from about 30° to about 60°, or from about 60° to about 90°. The modular robotic inspection system 100 may be operable to travel along the length of the tubular 105 through the bend 115. In embodiments, there may a plurality of bends 115 along the length of the tubular 105.

In one or more embodiments, the modular robotic inspection system 100 may comprise a first modular robot 120 and a second modular robot 125. As illustrated, the first modular robot 120 and the second modular robot 125 may be coupled together via a connecting member 130. In embodiments, the connecting member 130 may allow for both the first modular robot 120 and the second modular robot 125 to travel through the bend 115 in the tubular 105. In other embodiments, additional modular robots (not shown) may be coupled to the first and second modular robots 120, 125 through additional connecting members 130. In certain embodiments, the first modular robot 120 and the second modular robot 125 may comprise of different functions or may be operable to perform different functions. For example, the first modular robot 120 may be operable to provide sufficient power to displace both the first modular robot 120 and the second modular robot 125 through the tubular 105 while the second modular robot 125 may be operable to measure a parameter of or inspect the tubular 105. In other embodiments, the first modular robot 120 and the second modular robot 125 may comprise of the same functions or may be operable to perform the same functions. In these embodiments, both the first modular robot 120 and the second modular robot 125 may comprise the same dimensions and components.

As illustrated, the modular robotic inspection system 100 may further comprise a base unit 135. The base unit 135 may be disposed at an end 140 of the tubular 105 and secured to the vehicle 110 at that end 140. The base unit 135 may be secured through any suitable means. A tether 145 may be coupled to the base unit 135 and to the first modular robot 120, thereby coupling the first modular robot 120 to the base unit 135. Without limitations, any suitable cabling and/or wiring may be used for the tether 145. The tether 145 may be configured to provide electrical communication between the first modular robot 120 and the base unit 135. In addition, the tether 145 may comprise of sufficient tensile strength in order to pull the first modular robot 120 and the second modular robot 125 through the tubular 105 towards the base unit 135.

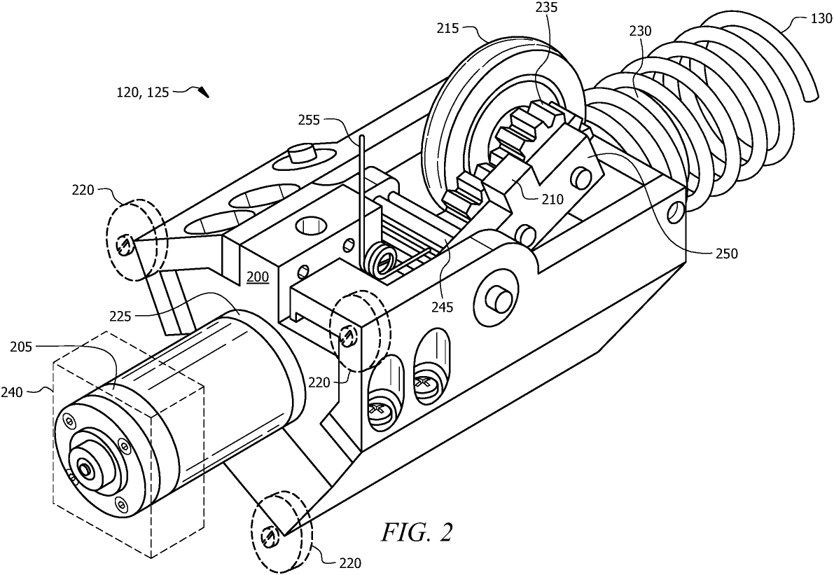

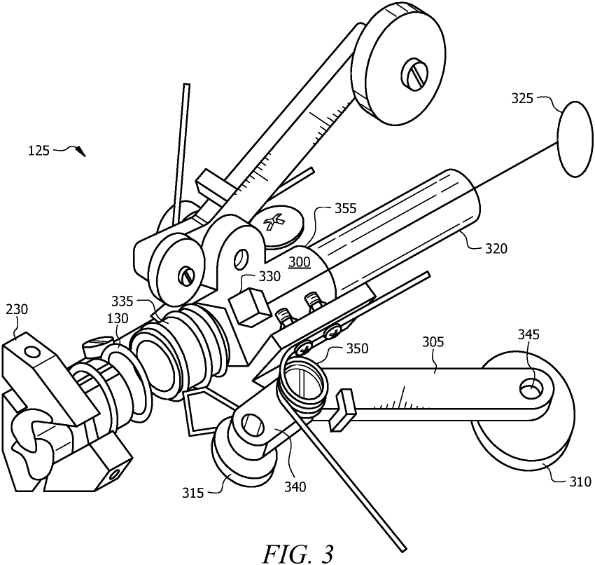

FIG. 2 illustrates an embodiment of the first modular robot 120 and/or the second modular robot 125. In certain embodiments, the second modular robot 125 may be configured to be the same or substantially similar to the first modular robot 120. In other embodiments, a different embodiment of the second modular robot 125 may be utilized by the modular robotic inspection system 100 (referring to FIG. 1) that is different from the first modular robot 120 (as shown in FIG. 3). For ease of description with regards to the present disclosure, although the modular robot illustrated in FIG. 2 may refer to an embodiment of the first modular robot 120 or the second modular robot 125, the modular robot to will be referred to as the “first modular robot 120”.

The first modular robot 120 may be operable to travel along the length of the tubular 105 (referring to FIG. 1) and through any number of bends 115 (referring to FIG. 1). In one or more embodiments, the first modular robot 120 may be any suitable size, height, shape, and any combinations thereof. In embodiments, the first modular robot 120 may comprise any suitable materials, including, but not limited to, metals, nonmetals, polymers, ceramics, composites, and any combinations thereof. As illustrated, the first modular robot 120 may comprise a first base 200, a first motor 205, a first set of extendable arms 210, a plurality of wheels 215, and a plurality of centralizing rollers 220. The first base 200 may be operable to support one or more components of the first modular robot 120. Each of the one or more components of the first modular robot 120 may be disposed at any suitable location in relation to the first base 200. In embodiments, each of the one or more components of the first modular robot 120 may be coupled to the first base 200 through any suitable means, including, but not limited to, fasteners, threading, welding, brazing, adhesives, and any combinations thereof.

As illustrated, the first motor 205 may be disposed at a first end 225 of the first base 200. The first motor 205 may be secured to the first end 225 through any suitable means. In one or more embodiments, the connecting member 130 may be disposed at a second end 230 of the first base 200, opposite to the first end 225. The first motor 205 may be operable to actuate the plurality of wheels 215 to rotate in order to provide motion to the first modular robot 120. In one or more embodiments, the tether 145 (referring to FIG. 1) may be coupled to the first motor 205 and operable to provide power to actuate the first motor 205. The first motor 205 may be indirectly coupled to each one of the plurality of wheels 215 via a gear train 235, wherein the gear train 235 may comprise any suitable number of gears operable to transmit power from the first motor 205 to each one of the plurality of wheels 215. Any suitable type of motor may be used as the first motor 205. For example, the first motor 205 may be a stepper motor. The first modular robot 120 may further comprise a motor cover 240 disposed at least partially over the first motor 205. The motor cover 240 may be any suitable size, height, shape, and any combinations thereof operable to structurally protect the first motor 205 from external objects.

In one or more embodiments, a proximal end 245 of each one of the first set of extendable arms 210 may be coupled to the first base 200. During operations, each one of the first set of extendable arms 210 may be operable to extend outwards from the first base 200 by rotating about the proximal end 245. Each one of the first set of extendable arms 210 may be any suitable size, height, shape, and any combinations thereof. As shown, one of each of the plurality of wheels 215 may be disposed at a distal end 250 of each one of the first set of extendable arms 210. In embodiments, as the first set of extendable arms 210 extends outwards from the first base 200, the plurality of wheels 215 may be displaced in relation to the distal end 250 of each one of the first set of extendable arms 210. In these embodiments, the plurality of wheels 215 may contact and apply pressure against an external surface (for example, the inner diameter of the tubular 105). As illustrated, there may be a spring 255 disposed proximate to the proximal end 245 of each one of the first set of extendable arms 210. Each spring 255 may be operable to bias one of the first set of extendable arms 210 outwards. For example, the spring 255 may be a torsion spring operable to force one of the first set of extendable arms 210 away from the first base 200.

Each one of the plurality of centralizing rollers 220 may be disposed near the spring 255 proximate to the proximal end 245 of each one of the first set of extendable arms 210. In embodiments, the plurality of centralizing rollers 220 may be smaller than the plurality of wheels 215. The plurality of centralizing rollers 220 may be operable to centralize or maintain a central position for the first modular robot 120. The plurality of centralizing rollers 220 may not be actuated by the first motor 205 but may be operable to rotate in relation to the movement of the first base 200. In embodiments, there may be any suitable number of the plurality of centralizing rollers 220 and/or of the plurality of wheels 215. In certain embodiments, the number of plurality of centralizing rollers 220 may be more than, an equivalent amount of, or less than the number of plurality of wheels 215.

FIG. 3 illustrates another embodiment of the second modular robot 125. In certain embodiments, the second modular robot 125 may be configured differently from the first modular robot 120 (referring to FIG. 2). Similar to the first modular robot 120, the second modular robot 125 may be operable to travel along the length of the tubular 105 (referring to FIG. 1) and through any number of bends 115 (referring to FIG. 1) in conjunction with the first modular robot 120. In one or more embodiments, the second modular robot 125 may be any suitable size, height, shape, and any combinations thereof. In embodiments, the second modular robot 125 may comprise any suitable materials, including, but not limited to, metals, nonmetals, polymers, ceramics, composites, and any combinations thereof. As illustrated, the second modular robot 125 may comprise a second base 300, a second set of extendable arms 305, a plurality of wheels 310, a plurality of centralizing rollers 315, a borescope camera 320, a mirror 325, and a second motor 330. The second base 300 may be operable to support one or more components of the second modular robot 125. Each of the one or more components of the second modular robot 125 may be disposed at any suitable location in relation to the second base 300. In embodiments, each of the one or more components of the second modular robot 125 may be coupled to the second base 300 through any suitable means, including, but not limited to, fasteners, threading, welding, brazing, adhesives, and any combinations thereof. As illustrated, the connecting member 130 may be disposed at a first end 335 of the second base 300, coupling the second modular robot 125 to the second end 230 of the first base 200 (referring to FIG. 2).

In one or more embodiments, a proximal end 340 of each one of the second set of extendable arms 305 may be coupled to the second base 300. During operations, each one of the second set of extendable arms 305 may be operable to extend outwards from the second base 300 by rotating about the proximal end 340. Each one of the second set of extendable arms 305 may be any suitable size, height, shape, and any combinations thereof. As shown, one of each of the plurality of wheels 310 may be disposed at a distal end 345 of each one of the second set of extendable arms 305. In embodiments, as the second set of extendable arms 305 extends outwards from the second base 300, the plurality of wheels 310 may be displaced in relation to the distal end 345 of each one of the second set of extendable arms 305. In these embodiments, the plurality of wheels 310 may contact and apply pressure against an external surface (for example, the inner diameter of the tubular 105). As illustrated, there may be a spring 350 disposed proximate to the proximal end 340 of each one of the second set of extendable arms 305. Each spring 350 may be operable to bias one of the second set of extendable arms 305 outwards. For example, the spring 350 may be a torsion spring operable to force one of the second set of extendable arms 305 away from the second base 300.

Each one of the plurality of centralizing rollers 315 may be disposed near the spring 350 proximate to the proximal end 340 of each one of the second set of extendable arms 305. In embodiments, the plurality of centralizing rollers 315 may be smaller than the plurality of wheels 310. The plurality of centralizing rollers 315 may be operable to centralize or maintain a central position for the second modular robot 125. The plurality of centralizing rollers 315 may be operable to rotate in relation to the movement of the second base 300. In embodiments, there may be any suitable number of the plurality of centralizing rollers 315 and/or of the plurality of wheels 310. In certain embodiments, the number of plurality of centralizing rollers 315 may be more than, an equivalent amount of, or less than the number of plurality of wheels 310.

As illustrated, the borescope camera 320 may be disposed at a second end 355 of the second base 300. The borescope camera 320 may be operable for visual inspection of the interior of the tubular 105 (referring to FIG. 1) by producing an image, collection of images, video, and any combination thereof when actuated. The borescope camera 320 may be provided power for actuation indirectly through the tether 145 (referring to FIG. 1) connected to the first modular robot 120 (referring to FIG. 2). The borescope camera 320 may be operable to process any incoming signals within a field of view of the borescope camera 320 to produce the image, collection of images, video, and any combination thereof.

A mirror 325 may be disposed at the second end 355 of the second base 300 adjacent to the borescope camera 320. As illustrated, the mirror 325 may be in an extended position from the second base 300 and may be at least partially within the field of view of the borescope camera 320. The mirror 325 may be operable to provide a reflection to the borescope camera 320, wherein the borescope camera 320 may process a reflected image, images, and/or video based on the reflection. In embodiments wherein the second modular robot 125 is traveling along a bend 115 (referring to FIG. 1), the bend 115 may obstruct a portion of the field of view of the borescope camera 320. The mirror 325 may be configured to mitigate this effect of the bend 115 and may provide a view further along the length of the tubular 105 past the bend 115. In one or more embodiments, the mirror 325 may be any suitable size, height, shape, and any combinations thereof and may comprise of any suitable material operable to produce a reflection.

As illustrated, the second modular robot 125 may comprise the second motor 330. The second motor 330 may be disposed about any suitable location along the second base 300. The second motor 330 may be operable to actuate the mirror 325 to rotate within the field of view of the borescope camera 320 in order to maintain a reflection for the borescope camera 320. Any suitable type of motor may be used as the second motor 330.

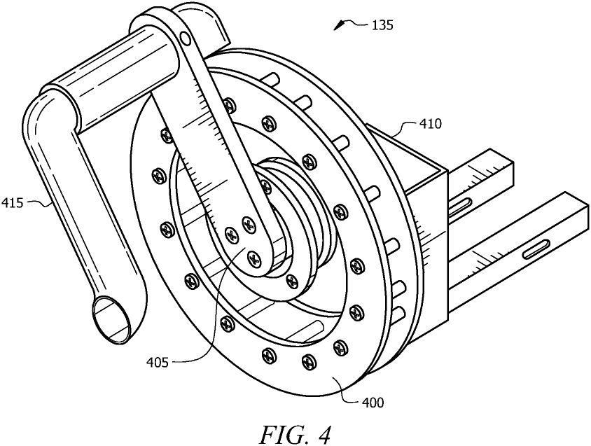

FIG. 4 illustrates an embodiment of the base unit 135. The base unit 135 may be operable to increase and/or decrease the length of the tether 145 (referring to FIG. 1) and to provide power through the tether 145 to the first modular robot 120 (referring to FIG. 1). In one or more embodiments, the base unit 135 may be any suitable size, height, shape, and any combinations thereof. In embodiments, the base unit 135 may comprise any suitable materials, including, but not limited to, metals, nonmetals, polymers, ceramics, composites, and any combinations thereof. During operations, the base unit 135 may be at least partially inserted into and/or secured to the tubular 105 (referring to FIG. 1). As illustrated, the base unit 135 may comprise a tether reel 400, a sensor 405, and a power source 410. The tether reel 400 may be operable to rotate and may house the tether 145 in a wound-up state. For example, the tether 145 may be wound within or onto the tether reel 400. As the tether reel 400 rotates, the tether 145 may become at least partially unwound and may be discharged from the tether reel 400. As the tether reel continues to rotate, the length of the tether 145 may increase. The sensor 405 may be disposed about the tether reel 400 and operable to measure the rotation of the tether reel 400. In embodiments, the sensor 405 may determine a length of the tether 145 based on the measured rotations of the tether reel 400. As illustrated, there may be a handle 415 coupled to the tether reel 400 configured to be actuated by an operator in order to rotate the tether reel 400. The power source 410 may be coupled to the tether reel 400 at any suitable location along the tether reel 400. The power source 410 may be any suitable source of power operable to provide power at least the first modular robot 120 through the tether 145. For example, the power source 410 may comprise of one or more batteries.

With reference to FIGS. 1-4, the method as presented in the present disclosure may be described. An operator may secure the base unit 135 of the modular robotic inspection system 100 to the end 140 of the tubular 105 to be inspected. The first modular robot 120 may be introduced into the tubular 105, wherein the second modular robot 125 may also be introduced while connected to the first modular robot 120 via the connecting member 130. The first motor 205 may be actuated to rotate the plurality of wheels 215 of the first modular robot 120 to travel along the length of the tubular 105. The second modular robot 125 may travel in conjunction with the first modular robot 120. As the first modular robot 120 travels, the base unit 135 may be actuated to increase the length of the tether 145 by rotating the tether reel 400. Both the first modular robot 120 and the second modular robot 125 may be actuated to travel about any suitable direction along the length of the tubular 105. Without limitations, the first modular robot 120 and the second modular robot 125 may travel horizontally, substantially horizontal, at an incline, at a decline, vertically, and any combinations thereof within the tubular 105. In embodiments, there may be sufficient friction between the plurality of wheels 215 of the first modular robot 120 and the inner diameter of the tubular 105 in order to travel at an incline and/or vertically through the tubular 105. As the second modular robot 125 travels through the tubular 105, the second modular robot 125 may be operable to measure a parameter within the tubular 105 (of the inner diameter) and/or operate the borescope camera 320 to take an image, images, video, or combinations thereof. The second modular robot 125 may further be operable to rotate the mirror 325 to provide a view further along the length of the tubular 105 past any one or more bends 115. In embodiments, the first modular robot 120 and the second modular robot 125 may be operable to travel through a bend 115 in the tubular 105. As the first modular robot 120 travels through the bend 115, at least one of the first set of extendable arms 210 may be actuated to contract inwards towards the first base 200, and at least one of the first set of extendable arms 210 may be actuated to extend outwards away from the first base 200. The connecting member 130 may be flexible and operable to bend based on the relative positioning between the first modular robot 120 and the second modular robot 125. In examples, the connecting member 130 may be a spring. As the second modular robot 125 travels through the bend 115, at least one of the second set of extendable arms 305 may be actuated to contract inwards towards the second base 300, and at least one of the second set of extendable arms 305 may be actuated to extend outwards away from the second base 300.

The present disclosure may provide numerous advantages, such as the various technical advantages that have been described with respective to various embodiments and examples disclosed herein. Other technical advantages will be readily apparent to one skilled in the art from the following figures, descriptions, and claims. Moreover, while specific advantages have been enumerated in this disclosure, various embodiments may include all, some, or none of the enumerated advantages.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A modular robotic inspection system, comprising:
a first modular robot, comprising:
a first base;
a first motor coupled to a first end of the first base;
a plurality of wheels disposed around the first base, wherein the first motor is operable to actuate the plurality of wheels, wherein each of the plurality of wheels is coupled to the first base through a first set of extendable arms, wherein each one of the plurality of wheels is disposed at a distal end of one of the first set of extendable arms; and
a plurality of centralizing rollers disposed around the first base, wherein each one of the plurality of centralizing rollers is disposed at a proximal end of one of the first set of extendable arms; and
a second modular robot, comprising:
a second base;
a plurality of wheels disposed around the second base, wherein each of the plurality of wheels is coupled to the second base through a second set of extendable arms, wherein each one of the plurality of wheels is disposed at a distal end of one of the second set of extendable arms; and
a plurality of centralizing rollers disposed around the second base, wherein each one of the plurality of centralizing rollers is disposed at a proximal end of one of the second set of extendable arms.

2. The modular robotic inspection system of claim 1, further comprising a base unit comprising:
a tether reel;
a sensor coupled to the tether reel and operable to measure rotation of the tether reel; and
a power source, wherein the power source is operable to actuate the tether reel and the sensor.

3. The modular robotic inspection system of claim 2, further comprising a tether, wherein the tether is coupled to the motor of the first modular robot and to the tether reel of the base unit.

4. The modular robotic inspection system of claim 3, wherein the base unit is operable to rotate to increase or decrease the length of the tether.

5. The modular robotic inspection system of claim 1, wherein the first modular robot further comprises a gear train indirectly coupling the first motor to each one of the plurality of wheels of the first modular robot, wherein the gear train is operable to transmit power from the motor to each one of the plurality of wheels.

6. The modular robotic inspection system of claim 1, wherein the first modular robot further comprises a plurality of springs, wherein each one of the plurality of springs of the first modular robot biases one of the first set of extendable arms away from the first base.

7. The modular robotic inspection system of claim 1, wherein the second modular robot further comprises a plurality of springs, wherein each one of the plurality of springs of the second modular robot biases one of the second set of extendable arms away from the second base.

8. The modular robotic inspection system of claim 1, wherein the second modular robot further comprises a borescope camera disposed at a second end of the second base.

9. The modular robotic inspection system of claim 8, wherein the second modular robot further comprises:
a mirror disposed at the second end of the second base and at least partially in a field of view of the borescope camera; and
a second motor coupled to the second base and operable to actuate the mirror to rotate.

10. The modular robotic inspection system of claim 1, wherein the second modular robot further comprises a second motor disposed at a first end of the second modular robot, wherein the second motor is operable to actuate the plurality of wheels of the second modular robot.

11. The modular robotic inspection system of claim 1, further comprising a connecting member disposed between the first modular robot and the second modular robot configured to couple a second end of the first modular robot to a first end of the second modular robot.

12. A modular robot, comprising:
a base;
a plurality of wheels disposed around the base, wherein each of the plurality of wheels is coupled to the base through a first set of extendable arms, wherein each one of the plurality of wheels is disposed at a distal end of one of the first set of extendable arms; and
a plurality of centralizing rollers disposed around the base, wherein each one of the plurality of centralizing rollers is disposed at a proximal end of one of the first set of extendable arms.

13. The modular robot of claim 12, further comprising a plurality of springs, wherein each one of the plurality of springs is operable to bias one of the first set of extendable arms away from the base.

14. The modular robot of claim 12, further comprising a motor disposed at a first end of the base, wherein the motor is operable to actuate the plurality of wheels of the modular robot.

15. The modular robot of claim 14, further comprising a gear train indirectly coupling the motor to each one of the plurality of wheels, wherein the gear train is operable to transmit power from the motor to each one of the plurality of wheels.

16. The modular robot of claim 14, further comprising a motor cover disposed at least partially over the motor operable to protect the motor.

17. The modular robot of claim 12, further comprising:
a borescope camera disposed at an end of the base; and
a mirror disposed at the end of the base and at least partially in a field of view of the borescope camera.

18. The modular robot of claim 17, further comprising a motor coupled to the base and operable to actuate the mirror to rotate.

19. The modular robot of claim 12, further comprising a connecting member disposed at an end of the base configured to couple the base to a second modular robot.

20. The modular robot of claim 12, wherein a number of the plurality of centralizing rollers is greater than a number of the plurality of wheels.
